(19) United States
(12) Patent Application Publication
(10) Pub. No.: US 2023/0127076 A1
(43) Pub. Date: Apr. 27, 2023

(54) PORTABLE TRAY FOR USE WITH A CONSOLE IN A VEHICLE

(71) Applicants: Stella IN, Germantown, MD (US); Hyunjeung IN, Germantown, MD (US)

(72) Inventors: Stella IN, Germantown, MD (US); Hyunjeung IN, Germantown, MD (US)

(21) Appl. No.: 17/512,666

(22) Filed: Oct. 27, 2021

(51) Int. Cl. B60N 3/00

(52) U.S. Cl. CPC B60N 3/002

(57) ABSTRACT

A portable tray for use in a vehicle is provided including a main tray body and two support parts coupled to a bottom surface of the main tray body. The two support parts are configured to be disposed on a console having two cupholders. The two supports parts of the portable tray are in an expanded configuration and are disposed inside the two cupholders of the console when the portable tray is disposed on the console for use.

### TECHNICAL FIELD

The present disclosure relates to an apparatus or a portable tray for use along with a console in a vehicle.

### BACKGROUND

In morder days, people spend more time in vehicles, and in particular, between different activites given a schedule. By way of example, parents often become chauffers to shuttle their children to various locations after school for extra curricular activities. While they are riding in vehicles between appointments, they often eat meals or snacks in the vehicles. During those times, people use one or more consoles in a vehicle to place drinks and snacks for consumption. However, the tray space provided by the consoles is often very small, limited. Because the consoles in the vehicle do not provide enough tray space for use by the occupants, sometimes it becomes an inconvenience and often it becomes a source for making a mess in the vehicle, while shuttling children between different scheduled activities.

Thus, there is still a need for an enhanced means for providing a larger portable tray space for use along with one or more consoles disposed inside the vehicles.

### SUMMARY

The present technology described herein provides an apparatus for use as a portable tray inside a vehicle.

In an aspect of the present disclosure, a portable tray for use in a vehicle includes a main tray body and two support parts coupled to a bottom surface of the main tray body. The two support parts are configured to be disposed on a console having two cupholders, and wherein the two support parts are in an expanded configuration and the two support parts are disposed inside the two cupholders of the console when the portable tray is placed on top of the console for use.

In another aspect of the present disclosure, the two support parts of the portable tray may be in a folded configuration when the portable tray is not used with the console in the vehicle.

In still another aspect of the present disclosure, the main tray body of the portable tray may be expanded in a direction, e.g., side way, for providing a wider space for use.

In another aspect of the present disclosure, the two support parts of the portable tray may comprise structures that are configured to collapse in the folded configuration and/or expand in the expanded configuration.

In another aspect of the present disclosure, the two support parts of the portable tray may be expanded in the expanded configuration such that the two support parts provide secure support for the main tray and the two support parts are disposed or seated inside the two cupholders of a console.

In another aspect of the present disclosure, the two support parts of the portable tray may include a metal and/or magnet part.

As such, the implementation of one or more aspects of the present disclosure may provide an enhanced portable tray with various benefits and convenience to people who desire to use a larger tray space in a secure manner inside a vehicle.

### BRIEF DESCRIPTION OF THE DRAWINGS

A more detailed understanding may be obtained from the following descriptions in conjunction with the following description, appended claims, and accompanying drawings.

FIG. 1 illustrates an example environment where the present technology is used in accordance with an aspect of the present disclosure.

FIG. 2A illustrates an example embodiment of the present disclosure in accordance with an aspect of the present disclosure.

FIG. 2B illustrates another example embodiment of the present technology in accordance with an aspect of the present disclosure.

FIG. 2C illustrates another example embodiment of the present technology in accordance with an aspect of the present disclosure.

FIG. 3A illustrates an example embodiment of the present technology in accordance with an aspect of the present disclosure.

FIG. 3B illustrates an example embodiment of of the present technology in accordance with an aspect of the present disclosure.

### DETAILED DESCRIPTION

The detailed description of illustrative examples will now be set forth below in connection with the various drawings. The description below is intended to be exemplary and in no way limit the scope of the claimed invention. It provides a detailed example of possible implementation(s) and is not intended to represent the only configuration in which the concepts described herein may be practiced. As such, the detailed description includes specific details for the purpose of providing a thorough understanding of various concepts, and it is noted that these concepts may be practiced without these specific details. In some instances, well known structures and components are shown in block diagram form in order to avoid obscuring such concepts. It should be noted that like reference numerals are used in the drawings to denote like elements and features.

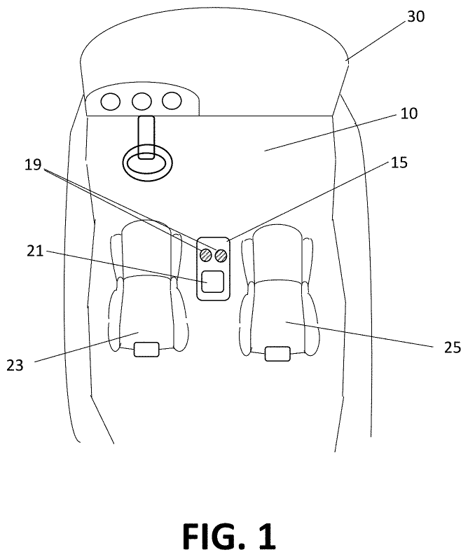

FIG. 1 illustrates a portion of an interior of a vehicle where an example embodiment of the present disclosure may be used. In the example, the vehicle 30 includes one or more consoles 15 may be disposed between seats 23, 25 and used for various purposes. Further, the one or more consoles 15 may include one or more cupholders 19 as well as other spaces 21 for use.

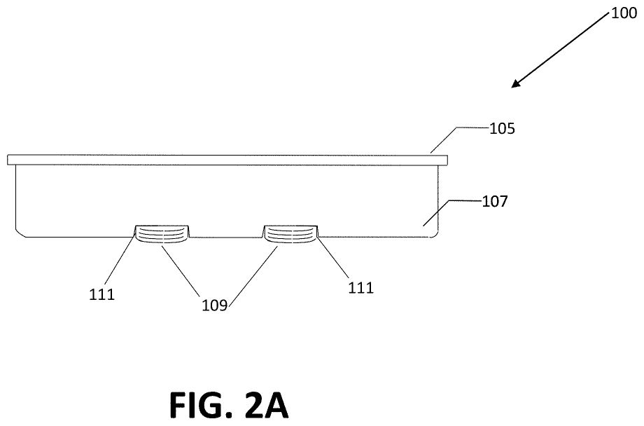

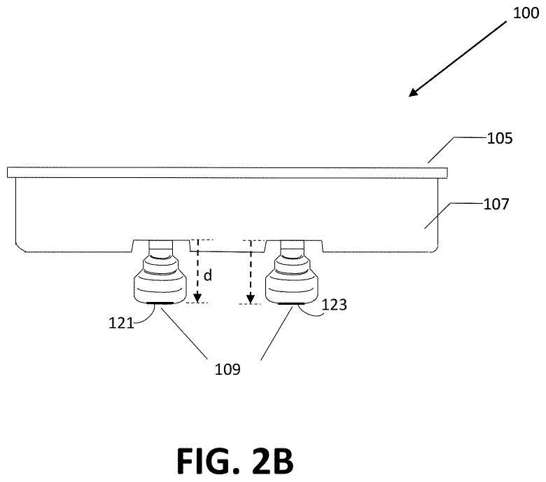

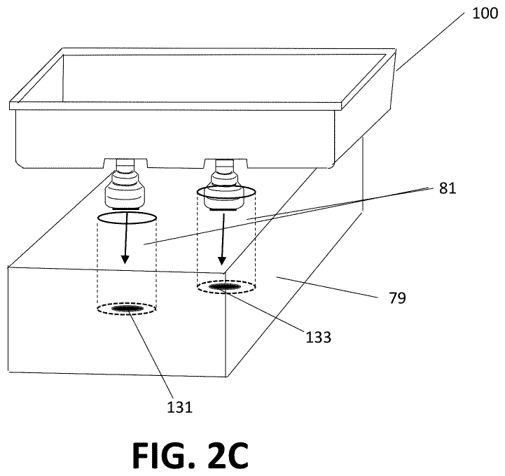

FIG. 2A illustrates a side view of an exemplary embodiment of the present technology in an aspect of the present disclosure. The embodiment 100 is a portable tray configured to include a main tray body 107 and two support parts 109 coupled to a bottom surface of the main tray body 107. The two support parts 109 are shown to be in a folded configuration seated inside recess areas. The embodiment 100 may also be configured to include a top 105 as an enclosure or lid. In the example, the two support parts 109 may be in either a folded configuration or an expanded configuration, depending upon whether the embodiment 100 is in use by being placed on top of the one or more consoles 15. Further, as shown in FIG. 2A, when in the folded configuration, the two support parts 109 are disposed inside recess areas 111 of the main tray body 107. Each of the recess areas 111 is configured to receive each of the two support parts 109 in its folded configuration.

FIG. 2B illustrates another side view of the embodiment 100 in another aspect of the present disclosure. That is, in FIG. 2B, the two support parts 109 of the portable tray are pulled out or expanded in the expanded configuration so that the portable tray 100 may be securely positioned on top of a console 15 disposed inside the vehicle as shown in FIG. 1. In particular, the two support parts 109 may be expanded downward or pulled down by hand for a distance d, e.g., 3″ in the expanded configuration and as a result the two support parts 109 may be disposed inside the cupholders 19 of the console 15 as shown in FIG. 1.

In an aspect of the present disclosure, the two support parts 109 may include structures that are configured to be collapsible as well as expandable when they are needed. When the two support parts 109 are collapsed, they are in a folded configuration and when they are expanded, they are in an expanded configuration. The structures of the two support parts 109 may include flexible plastic, or composite materials, etc. Further, in another aspect of the present disclosure, the ends of the two support parts 109 may include a metal or magnet part 123 so that the two support parts 109 may be securely positioned inside the cupholders of the console. In one implementation, the metal or magnet part 123 as well as corresponding metal or magnet parts 131, 133 disposed at a bottom of the cupholders of the console may provide firm, secure support for the portable tray 100 via magnetic attraction force.

FIG. 2C is a diagram conceptually illustrating how an example embodiment 100 of the present technology may be placed on top of a console 79 having two cupholders 81, in an aspect of the present disclosure. That is, the embodiment 100 may be securely placed, disposed or sitting on top of the console 79 disposed in a moving vehicle. In the example, the two support parts of the embodiment 100 are respectively disposed inside the cupholders 81 of the console 79 and via magnets and/or metals 121, 123, 131, 133. As such, the embodiment 100 may be securely placed on top of the console 79 and provide a larger tray area or space for use by occupants in the vehicle.

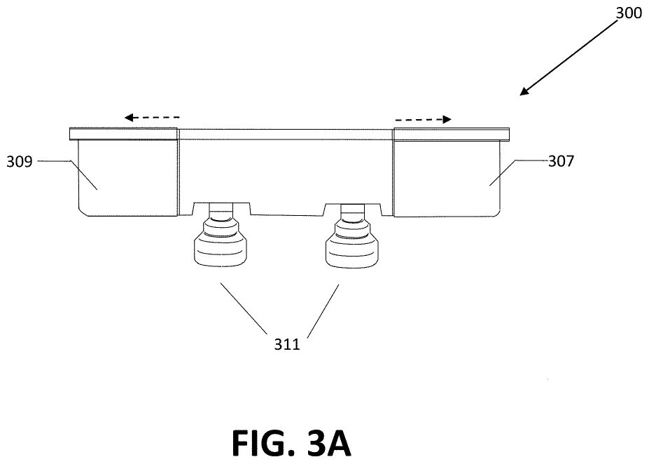

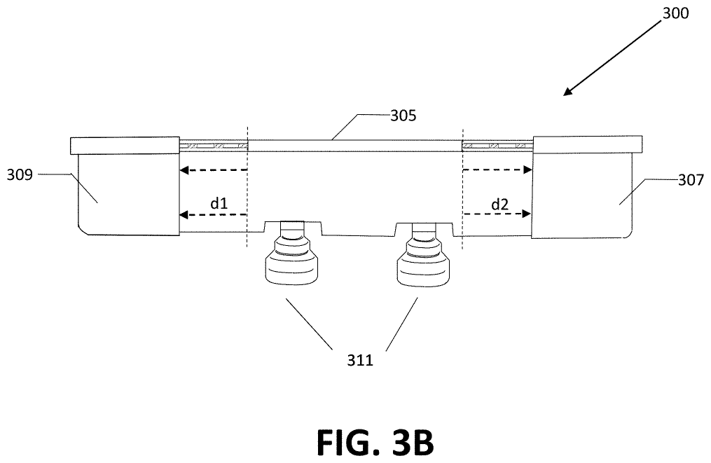

FIG. 3A and FIG. 3B illustrate another embodiment of the present technology in another aspect of the present disclosure. FIG. 3A shows an embodiment 300 with an expandable main tray body. The embodiment 300 may include two support parts that are collapsible and in the drawings FIGS. 3A and 3B show the two support parts in their expanded configurations. In FIG. 3A, the embodiment 300 may include an expandable main tray body with expandable portions 307, 309. The expandable portions 307, 309 may provide the embodiment 300 with a more tray space for use by occupants of a vehicle. That is, when desired for a larger tray space than a default tray space provided by the embodiment 300, the expandable portions 307, 309 of the main tray body may be pulled out or placed in an expanded position as shown in FIG. 3B. FIG. 3B illustrates the main tray body in the expanded position in which the main tray body is extended in a side way direction by a distance d′ on both sides. As such, by having the expandable portions 307, 309 fully expanded out, the embodiment 300 may be in a configuration to provide a much larger tray space for use by the occupants of the vehicle, while the embodiment 300 (or a portable tray) is disposed on a console having two cupholders. Also, the two support parts 311 of the embodiment 300 may be a certain distance apart from each other such that the two support parts 311 may be placed inside the two cupholders of the console disposed between seats in the vehicle as shown in FIG. 1. In another aspect of the present disclosure, the spacings of the two support parts 311 may be adjusted so that the two support parts 311 may be securely disposed inside the cupholders of the console.

Further, in still another aspect of the present disclosure, depending upon a vehicle occupant's need, one of the expandale portions 307 and 309 may be pulled out or expanded a different distance d1 or d2 by a vehicle occupant to provide him or her with a needed tray space for use. In one implementation, the main tray body may include a plurality of position mechanisms (e.g., grooves, stops, etc.) so that the expandable portions 307 or 309 may be pulled out and locked at different distances from a center line (not shown) of the main tray body. Further, when the fully expanded area is needed, however, the two expandable portions 307 and 309 may be fully pulled out or expanded in both directions, thereby providing the maximum size tray space that is possible with the embodiment 300 for use by the vehicle occupants.

As shown above, various embodiments of the present technology or portable trays in accordance with one or more aspects of the present disclosure provide an enlarged tray space for use by vehicle occupants, thereby increasing one or more utility functions of a console disposed in vehicles. Further, although descriptions of certain embodiments are provided for illustrative purpoases, other embodiments of the present technology may be possible and are not limited to the disclosed embodiments herein.

Further, it is noted that as used in the specification and the appended claims, the singular forms “a”, “an”, and “the” include plural referents or one or more items, unless the context clearly indicates otherwise. Also, no element, act, step, or instruction used in the present disclosure should be construed as critical or essential to the present disclosure unless explicitly described as such in the present disclosure. As used herein, except explicitly noted otherwise, the term “comprise” or variantions of the term, such as “comprising,” “comprises,” and “comprised” are not used to excluse other additives, components, integers or steps. The term “first,” “second,” and so forth used herein may be used to describe various components, but the components are not limited by the above terms. The above terms are used only to discriminate one component from other components, without departing from the scope of the present disclosure. Also, the term “and/or” as used herein includes a combination of a plurality of associated items or any item of the plurality of associated items. Further, it is noted that when it is described that an element is “coupled” or “connected” to another element, the element may be directly coupled or directly connected to the other element, or the element may be coupled or connected to the element through a third element. Also, the term “include” or “have” as used herein indicates that a feature, an operation, a component, a step, a number, a part or any combination thereof described herein is present. Furthermore, the term “include” or “have” does not excluse a possibility of presence or addition of one or more other features, operations, components, steps, numbers, parts or combinations. It is also noted that the foregoing relates only to exemplary embodiments of the present invention or technology and that numerous modifications or alternations may be made therein without departing from the spirit and the scope of the present disclosure as set forth in this disclosure.

Although the exemplary embodiments of the present disclosure are provided herein, the present disclosure is not limited to these embodimnets. There are numerous modifications or alternations that may suggest themselves to those skilled in the art. It is appreciated by one skilled in the art that a wide variety of alternate and/or equivalent implementations may be substituted for the specific examples shown and described without departing from the scope of the present disclosure. As such, the exemplary embodiments should not be construed in any way as imposing limitations upon the scope thereof. One the contrary, it is understood that various other embodiments, modifications, and equivalents thereof which, after reading the description herein, may suggest themselves to those skilled in the art without departing from the spirit of the present invention or disclosure and/or the scope of the appended claims.

What is claimed is:

1. A portable tray for use in a vehicle, the portable tray comprising:
a main tray body;
two support parts coupled to a bottom surface of the main tray body,
wherein the two support parts are configured to be disposed on a console having two cupholders in the vehicle; and
wherein the two support parts are in an expanded configuration, the two support parts being disposed inside the two cupholders of the console, when the portable tray is disposed for use on the console.

2. The portable tray of claim 1, wherein the two support parts of the portable tray are in a folded configuration when the portable tray is not used with the console in the vehilce

3. The portable tray of claim 1, wherein the main tray body of the portable tray is expanded in a direction for providing a wider space for use.

4. The portable tray of claim 3, wherein the two support parts of the portable tray comprise structures that are configured to collapse in the folded configuration and/or expand in the expanded configuration.

5. The portable tray of claim 1, wherein the two support parts of the portable tray are expanded in the expanded configuration such that the two support parts of the portable tray provide secure support for the main tray body by having the two support parts being disposed inside the two cupholders.

6. The portable tray of claim 1, wherein the two support parts of the portable tray comprise a metal and/or magnet part.
